(19) United States
(12) Patent Application Publication
(10) Pub. No.: US 2024/0328554 A1
(43) Pub. Date: Oct. 3, 2024

(54) COUPLING ASSEMBLY FOR A HVACR SYSTEM

(71) Applicant: CRAFT GROUP, San Diego, CA (US)

(72) Inventor: Dean Rafiee, San Diego, CA (US)

(73) Assignee: CRAFT GROUP, San Diego, CA (US)

(21) Appl. No.: 18/621,002

(22) Filed: Mar. 28, 2024

Related U.S. Application Data
(60) Provisional application No. 63/455,171, filed on Mar. 28, 2023.

(51) Int. Cl. F16L 37/35; F25B 41/24; F25B 41/40

(52) U.S. Cl. CPC F16L 37/35; F25B 41/24; F25B 41/40

(57) ABSTRACT

The present invention discloses a coupling assembly for a HVACR system. The coupling assembly is configured to engage and disengage at least one port of the HVACR system. The coupling assembly comprises a female coupling member and a male coupling member. The male coupling member is configured to lock with the female coupling member. The coupling assembly is configured with a three-stage sealing structure and self-sealing valve to ensure a highest level of reliability, toughness, and durability to eliminate refrigerant leakage, and prevent any restriction, or pressure drop in the HVACR systems.

### CROSS-REFERENCE TO RELATED APPLICATIONS

This application claims priority to U.S. Provisional Application 63/455,171 for COUPLING ASSEMBLY FOR A HVACR SYSTEM filed Mar. 28, 2023, the contents of which are incorporated herein by reference in their entirety.

### TECHNICAL FIELD

The present invention generally relates to heating, ventilation, air conditioning, and refrigeration (HVACR) system, and, more particularly, to a coupling assembly for a HVACR system.

### INTRODUCTION

Coupling members are commonly employed to facilitate charging and evacuation of a pressurized fluid system, such as a refrigeration system, an air conditioning system, or a hydraulic system. The fluids, for example, propane, isobutane, and semi-flammable refrigerants in the pressurized system are flammable, hazardous, and unsuitable to release in the environment. Therefore, the coupling member that prevents leakage of fluid is desired. Specifically, the coupling member needs to prevent leakage when the fluid system under service is connected to and disconnected from the system that supplies fluid.

Few existing patent applications attempt to address the problems cited in the background as prior art over the presently disclosed subject matter and are explained as follows.

U.S. Pat. No. 6,539,970 assigned to Steven M. Knowles et al. entitled “Method and apparatus for servicing a pressurized system” discloses a purge fitting that allows air that may be trapped in the pressurized system to be vented by depressing a purge actuator, such as a purge button attached to the fitting. The air could be vented from an opening adjacent to the actuator or other orifice. The apparatus further discloses a self-sealing valve assembly that prevents the opening of the coupling member until a proper coupling interconnection is made with a system to be serviced. The purge fitting is incorporated in the coupling member or other service device.

US20130341917A1 assigned to Charles A. Lehmann et al. entitled “Quick connect and quick disconnect system female component” discloses a quick connect/disconnect system by using connectors for a fluid system, wherein the system includes a fluid channel, a mating feature, a female component with a coupling portion that is configured to couple with a male component, a shutoff plug, a seal member such as an O-ring, a spacer, a male connecting body and a biasing member, and a locking mechanism with an annular groove for receiving the seal member. The seal member prevents leakage between the male and female components.

However, the existing systems and apparatuses fail to provide an effective design that ensures to prevent leakage and escape of refrigerant during the connection and disconnection operations.

Therefore, there is a need for a coupling assembly that ensures the highest level of reliability, toughness, and durability to eliminate refrigerant leakage, and prevents any restriction or pressure drop in the pressurized fluid system. Further, the coupling assembly need to prevent leakage and escape of refrigerant during the connection and disconnection operations of the coupling assembly and the pressurized fluid system.

### SUMMARY

The present invention discloses a coupling assembly comprising a female coupling member and a male coupling member. The male coupling member is configured to lock with the female coupling member. The coupling assembly may be configured for use with a pressurized fluid system, for example, a HVACR system. The coupling assembly is configured to engage and disengage at least one port of the HVACR system.

The female coupling member comprises a front portion and a rear portion. The female coupling member further comprises at least one female sealing member, a first sleeve, a first spring, and a first poppet assembly. The at least one female sealing member may comprise a first resilient sealing member disposed at the front portion of the female coupling member and a second resilient sealing member disposed at the rear portion of the female coupling member. The first spring may be disposed adjacent to the first resilient sealing member and the first poppet assembly may comprise a first poppet and a first bonded poppet.

The male coupling member comprises at least one male sealing member, a second spring and second poppet assembly comprising a second poppet and a second bonded poppet. The at least one male sealing member may comprise a third resilient sealing member and the second spring may be disposed adjacent to the third sealing member.

The coupling assembly is configured to operate in three modes including a disconnected mode, a partially connected mode and a fully connected mode.

In one embodiment, the coupling assembly is a self-sealing coupling assembly. The coupling assembly is configured with safety locking and sealing features that prevent leaks and other hazards. In an embodiment the coupling assembly is further configured with a three-stage sealing structure which is contemplated to provide a high level of reliability, toughness, and durability to eliminate refrigerant leakage. It is further contemplated that in some embodiments, the coupling assembly may prevent any restriction or pressure drop in the pressurized fluid system, for example, refrigeration systems.

In one embodiment, the coupling assembly is further configured with a thread type configuration to allow easy connection and disconnection from the pressurized fluid system. In one embodiment, the coupling assembly comprises a metal body and metal connections. For example, in an embodiment, the coupling assembly comprises a brass body and copper connections which are contemplated to prevent corrosion-related problems of the assembly. However, any material may be utilized, and the aforementioned embodiment is provided as a non-limiting example. In some embodiments, the coupling assembly may provide a water-tight seal. Further, in an embodiment, the coupling assembly may facilitate copper sweat style connections, which is contemplated to simplify the installation process by eliminating the need for flux and flux residue clean up and saves time and money. Of course, flux or other connection means may, in some embodiments, be utilized.

Further it is contemplated that the coupling assembly may prevent pressure drop, which is contemplated to improve the efficiency of the system connected to the coupling assembly. In an embodiment, the coupling assembly comprises self-sealing valving, which may prevent leakage of refrigerant when the system connected to the coupling assembly is disconnected. In one embodiment, the coupling assembly is configured with the metal-to-metal seal, which eliminates refrigerant loss when the coupling assembly is connected to the pressurized fluid system.

Other objects, features, and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of a coupling assembly, according to an embodiment of the present invention.

FIG. 2 exemplarily illustrates a cross-sectional view of a female coupling member of the coupling assembly, according to an embodiment of the present invention.

FIG. 3 exemplarily illustrates a simplified representation of a female coupling member, according to an embodiment of the present invention.

FIG. 4 exemplarily illustrates a cross-sectional view of a male coupling member of the coupling assembly, according to an embodiment of the present invention.

FIG. 5 exemplarily illustrates a cross-sectional view of a rear portion of the female coupling member, according to an embodiment of the present invention.

FIG. 6 exemplarily illustrates a perspective view of the coupling assembly, according to another embodiment of the present invention.

FIG. 7 exemplarily illustrates a perspective view of the coupling assembly, according to yet another embodiment of the present invention.

FIG. 8 exemplarily illustrates a side view of the male coupling member of the coupling assembly, according to an embodiment of the present invention.

FIG. 9 exemplarily illustrates a portion of the female coupling member of the coupling assembly, according to an embodiment of the present invention.

FIG. 10 exemplarily illustrates a spring member, according to an embodiment of the present invention.

FIG. 11 exemplarily illustrates a perspective view of a stem valve of the coupling assembly, according to an embodiment of the present invention.

FIG. 12 exemplarily illustrates an exploded view of the male coupling member, according to an embodiment of the present invention.

FIG. 13 exemplarily illustrates a side view of the female coupling member, according to an embodiment of the present invention.

FIG. 14 exemplarily illustrates an exploded view of the female coupling member, according to an embodiment of the present invention.

### DETAILED DESCRIPTION OF EMBODIMENTS

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

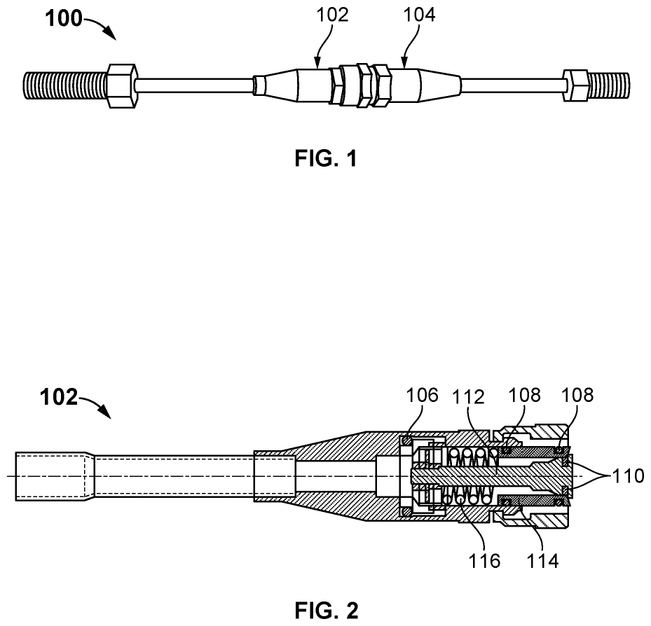

FIG. 1 discloses a coupling assembly 100 according to an embodiment of the present invention. The coupling assembly 100 may be utilized with any system that a person of ordinary skill may recognize or desire. Reference is made throughout this disclosure to the coupling assembly 100 being utilized with a HVACR system, however, such reference is provided as example only and does not limit the scope of the invention. For example, the coupling assembly 100 may be configured to engage and disengage at least one port of the HVACR system. The coupling assembly 100 could be further used with any pressurized fluid system. The coupling assembly 100 comprises a female coupling member 102 and a male coupling member 104. The male coupling member 104 is configured to secure to the female coupling member 102. In some embodiments, the male coupling member 104 is configured to lock with the female coupling member 102.

Referring to FIG. 2, the female coupling member 102 comprises a first resilient sealing member 106 disposed at a front portion of the female coupling member 102, a first sleeve 114 disposed at a rear portion of the female coupling member 102, a second resilient sealing member 108 disposed at the rear portion of the female coupling member 102, a first spring 116 disposed adjacent to the first resilient sealing member 106 and a first poppet assembly comprising a first poppet 112 and a first bonded poppet 110.

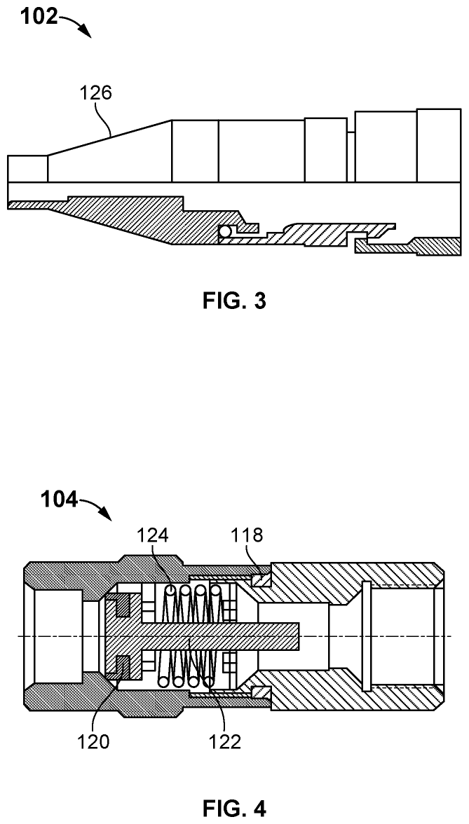

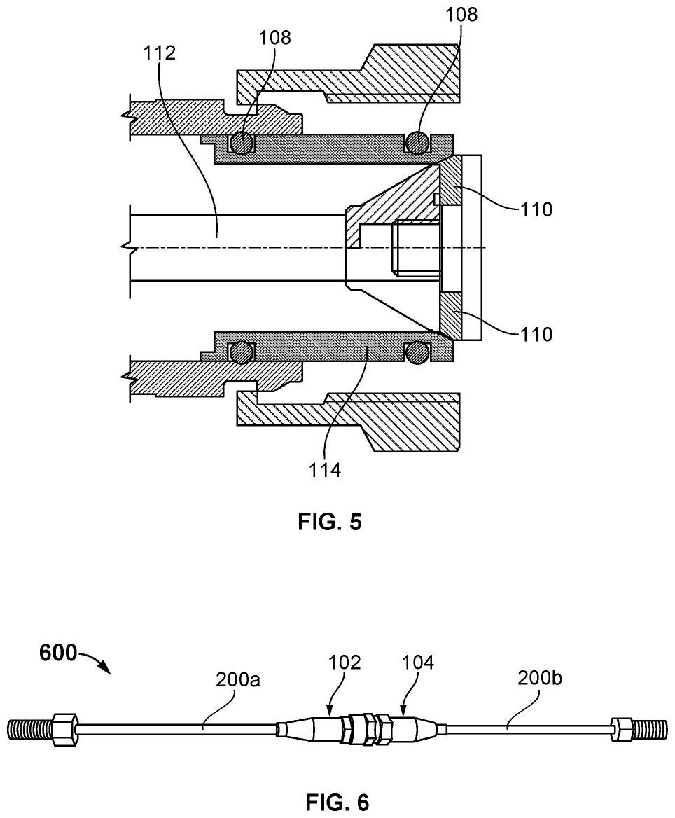

FIG. 3 exemplarily illustrates a simplified representation of female coupling member 102, according to an embodiment of the present invention. A portion 126 of the female coupling member 102 which is contemplated to permit the female coupling member 102 to couple to an external system. For example, the portion 126 of the female coupling member 102 could be customized to connect with a port of the pressurized fluid system, or HVACR system. The portion 126 may have any shape, form, or size that a person of ordinary skill may desire. In one embodiment, the portion 126 and the female coupling member 102 may be independent elements that may be secured together. For example, and without limitation, the portion 126 and the female coupling member 102 may secure via a threaded connection or other connection that a person of ordinary skill in the art may desire. However, in another embodiment, the portion 126 and the female coupling member 102 may be permanently secured.

Referring to FIG. 4, the male coupling member 104 comprises a third resilient sealing member 118, a second spring 124 disposed adjacent to the third resilient sealing member 118 and a second poppet assembly comprising a second poppet 122 and a second bonded poppet 120.

As described, the sealing members (106, 108, 118) are resilient, however, in other embodiments, the sealing members (106, 108, 118) may comprise any characteristic that a person of ordinary skill may desire.

FIG. 6 illustrates a perspective view of the coupling assembly 600, according to another embodiment of the present invention. The female coupling member 102 may be secured to a first tubing 200a and the male coupling member 104 may be secured to a second tubing 200b. The female coupling member 102, the male coupling member 104, and any of the first and second tubing 200a,b may comprise any of the characteristics discussed herein. Likewise, FIG. 7 illustrates a perspective view of the coupling assembly 700, according to yet another embodiment of the present invention. Referring to FIGS. 6-7, the tubing 200a,b connecting the female coupling member 102 and the male coupling member 104 has a different length and could be customized based on the desire of a person of ordinary skill in the art. Referring to FIG. 3 and FIG. 7, the portion 126 of the female coupling member 102 could be customized to secure to the tubing 200a. In such an embodiment, the female coupling member 102 comprises a portion 126 configured to connect with an external system (not shown). It is contemplated that the tubing 200a may be configured to permit connection between the external system and the portion 126. The portion 126 may be integrated with the female coupling member 102 or may be secured, permanently or removably, with the female coupling member 102.

The connection between the tubing 200a,b and the male and female coupling members 102, 104 shown in FIGS. 6-7 are provided as non-limiting examples only. It is contemplated that the connection may be any connection that a person of ordinary skill in the art may desire. For example, the connection may comprise any shape, form, or size, that may be desired.

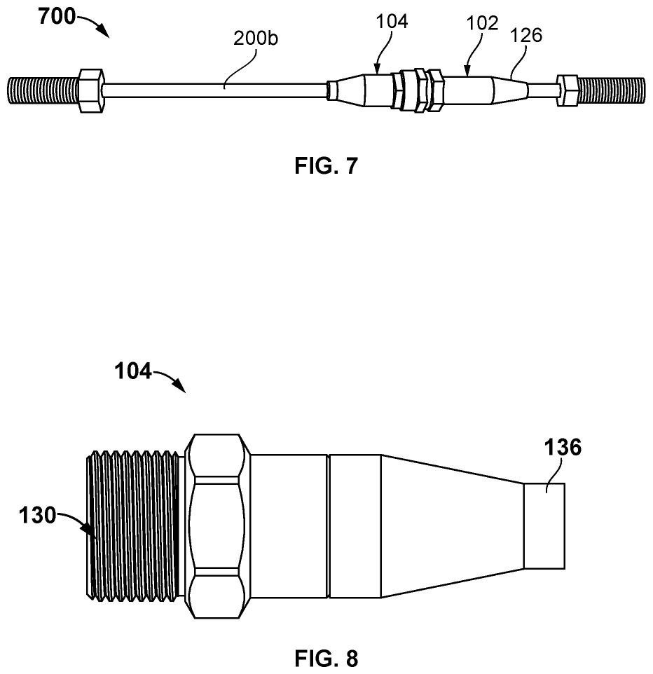

FIG. 8 exemplarily illustrates a side view of the male coupling member 104 according to an embodiment of the present invention. FIG. 12 illustrates an exploded view of the male coupling member 104 shown in FIG. 8. The male coupling member 104 comprises the second poppet assembly 138, a first ejector spring stopper 132, a second ejector spring stopper 134, the second spring or ejector spring 124, integral nozzle 130, a female tube connector 136 and the third resilient sealing member 118.

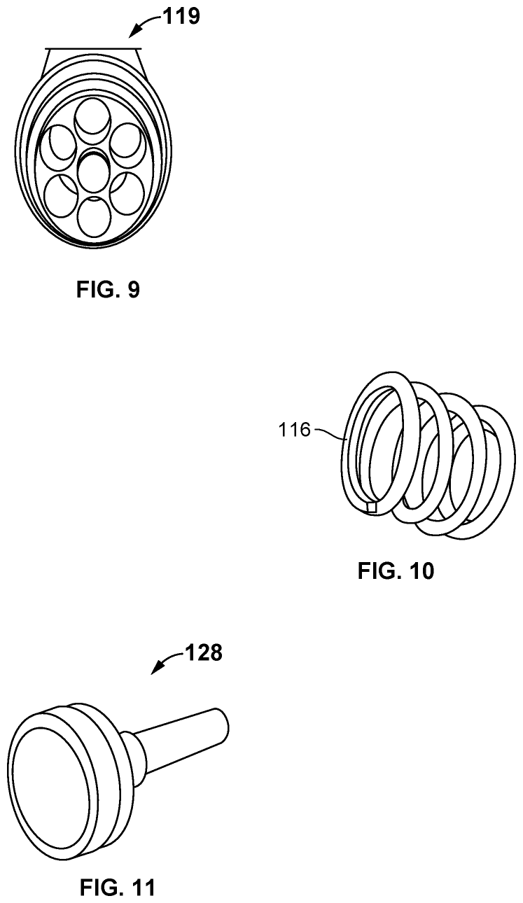

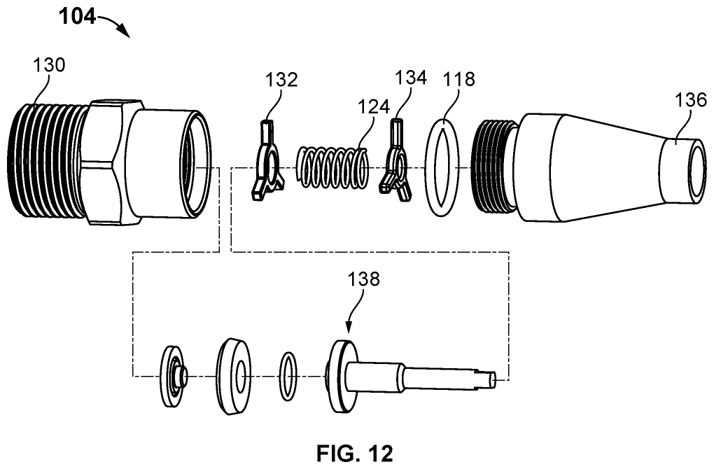

FIGS. 9-11 illustrate components of the female coupling member 102 of the coupling assembly 100, according to an embodiment of the present disclosure. More particularly, FIG. 9 illustrates an aerator. FIG. 10 illustrates an embodiment of the spring 116. While reference is made to the first spring 116, the second spring 124 may comprise any of the same properties of the first spring 116. FIG. 11 illustrates one embodiment of a stem valve 128. In one embodiment, the stem valve 128 may be a self-sealing valve configured to permit fluid into any of the female coupling member 102 and sealing any of the female coupling member 102.

The coupling assembly 100 is configured to operate in three modes including a disconnected mode, a partially connected mode, and a fully connected mode.

As a nonlimiting example, the operation of one embodiment of the coupling assembly 100 in the fully connected mode is disclosed as follows. The male coupling member 104 and the female coupling member 102 are coupled together by continued tightening of a union nut of the female coupling member 102. In the fully connected mode, a fluid passage of the coupling assembly 100 opens by forcing the second poppet assembly 138 and the first sleeve 114 of the female coupling member 102 to open. In one embodiment, a metal ring disposed at the front portion of the male coupling member 104 forms a leak-free metal-to-metal seal. Further, in another embodiment, the first and second resilient sealing members 106, 108 of the female coupling member 102 and the third resilient member 118 of the male coupling member 104 may form a leak free seal. It is contemplated that the coupling assembly 100 is configured to meet the standards set by UL.

One embodiment of the operation of the coupling assembly 100 in the partially connected mode is disclosed as follows. As the male coupling member 104 and female coupling member 102 are threaded together, the O-ring, or the second resilient sealing member 108 on the first sleeve 114 creates a seal, which prevents leakage of refrigerant. Then, the sealing surface of the male coupling member 104 contacts the bonded seal of the first sleeve 114 of the female coupling member 102. At the same time, the stem valve 128 head in the female coupling member 102 contacts the second bonded poppet 120 of the male coupling member 104, forcing air out of the coupling assembly 100. During this stage, the male coupling member 104 and female coupling member 102 are sealed. It is contemplated that sealing the male coupling member 104 and the female coupling member 102 may prevent fluid leakage. In one embodiment, the second resilient sealing member 108 on the first sleeve 114 of the female coupling member 102 may transition from a partially connected status to a fully connected status, which is contemplated to help prevent leakage of fluid during and after connecting process. The fluid may be any fluid that a person of ordinary skill may desire, including, for example, refrigerant.

One embodiment of the operation of the coupling assembly 100 in the disconnected mode is disclosed as follows. When the male coupling member 104 and female coupling member 102 are disconnected, spring-loaded valve assemblies in the male coupling member 104 and female coupling member 102 are sealed to prevent fluid loss and the inclusion of air or foreign materials. The second spring 124 in the male coupling member 104 presses the second bonded poppet 120 against the sealing surface of the coupling body. Likewise, the first spring 114 in the female coupling member 102 presses the first sleeve 114 against the sealing surface of the head of the stem valve 128. In one embodiment, there are two O-rings, or in another embodiment the first resilient sealing member 106 and the second resilient sealing member 108, at the front-end and back-end portion of the female coupling member 102 to prevent leakage between the first sleeve 114 and coupling body. The third O-ring or the third resilient sealing member 118 at the male coupling member 104 is configured to prevent leakage between the sleeve and coupling body. Furthermore, the third resilient sealing member 118 works on the first sleeve 114 of the female coupling member 102 when the couplings are disconnected.

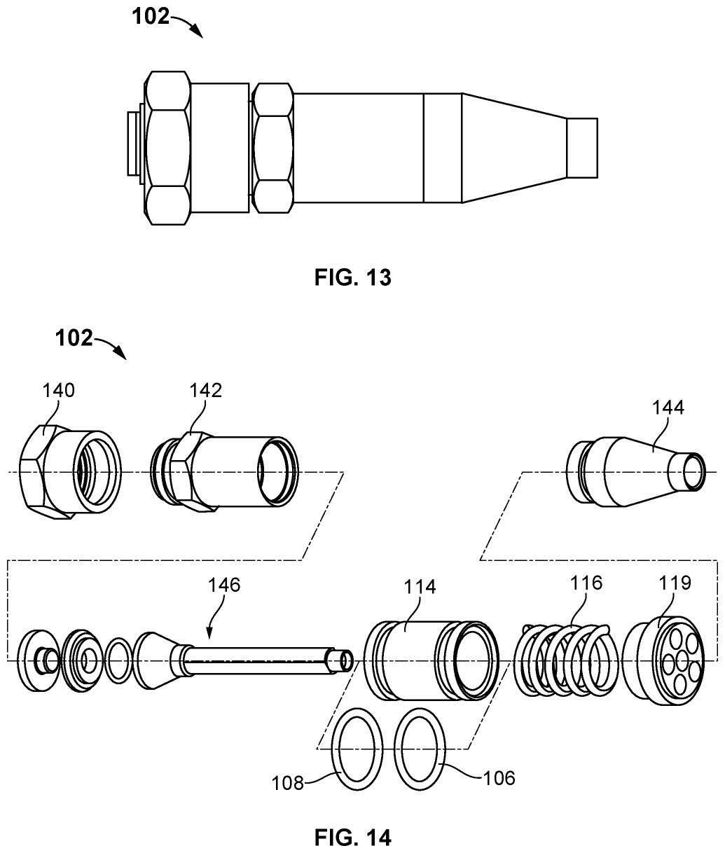

FIG. 13 and FIG. 14 exemplarily illustrate a side view and an exploded view of the female coupling member 102, respectively, according to an embodiment of the present invention. The female coupling member 102 comprises the first poppet assembly 146, the first sleeve 114, the aerator 119, the first resilient sealing member 106, the second resilient sealing member 108, the first spring 116, a movable nut 140, an integral nozzle 142 and a female tube connector 144. In one embodiment, the aerator 119 may receive an end of the first poppet assembly 146 to secure, permanently or removably, the aerator 119 and the first poppet assembly 146. For example, a central hole in the aerator 119 may receive the end of the first poppet assembly 146 during manufacturing and the end of the first poppet assembly 146 may be crimped, or otherwise manipulated, to permanently secure the aerator 119 and the first poppet assembly 146. In some embodiments, securing the aerator 119 and the first poppet assembly 146 may likewise secure any of the first sleeve 114, first resilient sealing member 106, second resilient sealing member 108, and the first spring 116 in position within the female coupling member 102 when assembled.

In some embodiments, the coupling assembly 100 is made of metal. In one embodiment, the coupling assembly 100 includes a brass body and copper connections which ensures prevention of corrosion-related problems of the assembly 100. The brass body of the coupling assembly 100 enables connection with pipes made of material, including, but not limited to, copper or metals through brazing or welding. The coupling assembly 100 prevents pressure drop, which improves the efficiency of the system connected to the coupling assembly 100. The coupling assembly 100 is configured with self-sealing valving, which prevents leakage of fluid when the system connected to the coupling assembly 100 is disconnected. The coupling assembly 100 is further configured with the metal-to-metal seal, which eliminates fluid loss when the coupling assembly 100 is connected to the pressurized fluid system.

In one embodiment, the coupling assembly 100 is further configured with a thread type configuration to allow easy connection and disconnection from the pressurized fluid system. The coupling assembly 100 further enables copper sweat connections, which simplifies the installation process by eliminating the need for flux and flux residue clean up and saves time and money. However, the coupling assembly may comprise any configuration and may utilize any number of coupling means that a person of ordinary skill in the art may desire.

In one embodiment, the coupling assembly 100 is a self-sealing coupling. The coupling assembly 100 is configured with safety locking and sealing features that prevent leaks and other hazards and helps to reduce environmental footprint. The coupling assembly 100 is further configured with a three-stage sealing structure to which is contemplated to ensure a high level of reliability, toughness, and durability to eliminate fluid leakage. Further, the three-stage sealing structure may prevent any restriction or pressure drop in the pressurized fluid system, for example, the HVACR system and the refrigeration systems. The coupling assembly 100 is further configured with copper connection and attachment that uses a unique brazing and locking method in combination with a copper thickness to meet and excel UL pull testing standards.

It is contemplated that the coupling assembly 100 may be configured to enable pre-charging, vacuuming, and ease of servicing of pressurized fluid system, for example, refrigeration, AC, and heat pump systems. Further, the coupling assembly 100 may enable easy maintenance and installation of refrigeration and air conditioning systems including, but not limited to, commercial refrigeration, marine refrigeration and air conditioning systems, split refrigeration, portable AC system, portable refrigeration system, and refrigerated dry cleaning systems. In one embodiment, the disconnection of the coupling assembly 100 from the pressurized fluid system maintains minimum to no air inclusion and fluid loss.

It is contemplated that the coupling assembly 100 could be used in thermal heat transfer applications, HVACR systems, and heat transfer industry. The coupling assembly 100 could be used with a wide range of refrigerants including, but not limited to, flammable refrigerants. The flammable refrigerants, including, but not limited to, A3 refrigerants, propane (R290) and isobutane (R600a), and other semi-flammable refrigerants (A2L), which have a lower global warming potential than traditional refrigerants (HFCs). The coupling assembly 100 could be used in testing, vacuuming, charging, and serving refrigeration systems at a plant or in the field, which enables the manufacturer to install, service, maintain, and manufacture pressurized fluid system, for example, a R290 system, and HVACR system. The coupling assembly 100 of the present invention may meet the UL109 requirements for flammable refrigerants.

The coupling assembly 100 may be provided with copper connection(s) with different thicknesses depending on the size of the male and female coupling members (104, 102). For example, the coupling assembly 100 may comprise a thickness between 0.005″ and 0.1″. In one embodiment, the thickness may be between about 0.032″ and 0.047″. The coupling assembly 100 may, in some embodiments, be equipped with safety locking and sealing mechanism that prevents refrigerant leaks, and pressure drops within the HVAC/R system. It is contemplated that the safety locking and sealing mechanism may be any mechanism that a person of ordinary skill may desire. Further, in one embodiment, the coupling assembly 100 could be used with flammable refrigerants to solve multiple problems faced by in the technicians and original equipment manufactures in the HVAC/R industry and may meet UL109/ASHREA 15 requirements/standards, including, for example, any of a pull strength test, pressure test, Tensile Strength and Elongation Test, for A3, A2L, and HFC refrigerants.

Many HVAC/R original equipment manufacturers (OEMS) do not have refrigerant charging capabilities for A2L, and A3 refrigerants at their plants. The coupling assembly 100 could allow the OEMS to install the evaporator and condensing unit in the HVAC/R system without the need of brazing copper tubes. The coupling assembly 100 could allow contractors to install systems precharged with refrigerants which eliminates the use of torch.

### EXAMPLE

Further, examples of the pull test performed for ¼, ⅜, ½ ⅝, and ¾ couplings based on the force requirement of UL109 (R290) are provided as follows. In this case, the recommended thickness of ¼ to be 0.032″, and ⅜ and ½ to be 0.035″ is contemplated.

TABLE 1

| Size of | Tested Pull | Required for | | |
|---|---|---|---|---|
| Coupling | Force KG | R290 KG | Result | Remark |
| ¼ | 251 | 222.4 | Pass | 0.032″ |
| | | | | thickness for |
| | | | | ¼ tube |
| ⅜ | 408 | 355.8 | Pass | 0.035″ |
| | | | | thickness for |
| | | | | ⅜ tube |
| ½ | 531 | 511.5 | Pass | 0.035″ |
| | | | | thickness for |
| | | | | ½ tube |
| ⅝ | 735 | 712 | Pass | 0.045″ |
| | | | | thickness for |
| | | | | ⅝ tube |
| ¾ | 923 | 890 | Pass | 0.047″ |
| | | | | thickness for |
| | | | | ¾ tube |

Preferred embodiments of this innovation are described herein, including the best mode known to the innovators for carrying out the innovation. It should be understood that the illustrated embodiments are exemplary only and should not be taken as limiting the scope of the innovation.

The foregoing description comprises illustrative embodiments of the present innovation. Having thus described exemplary embodiments of the present innovation, it should be noted by those skilled in the art that the disclosures within this document are exemplary only, and that various other alternatives, adaptations, and modifications may be made within the scope of the present innovation. Merely listing or numbering the steps of a method in a certain order does not constitute any limitation on the order of the steps of that method. Many modifications and other embodiments of the innovation will come to mind to one skilled in the art to which this innovation pertains having the benefit of the teachings in the foregoing descriptions. Although specific terms may be employed herein, they are used only in a generic and descriptive sense and not for purposes of limitation. Accordingly, the present innovation is not limited to the specific embodiments illustrated herein.

What is claimed is:

1. A coupling assembly for a heating, ventilation, air conditioning, and refrigeration (HVACR) system, comprising:
a female coupling member comprising a first resilient sealing member disposed at a front portion of the female coupling member, a first sleeve disposed at a rear portion of the female coupling member, a second resilient sealing member disposed at the rear portion of the female coupling member, a first spring disposed adjacent to the first sealing member and a first poppet assembly including a first poppet and a first bonded poppet; and
a male coupling member, configured to couple with the female coupling member, the male coupling member comprising a third resilient sealing member, a second spring disposed adjacent to the third resilient sealing member and a second poppet assembly including a second poppet and a second bonded poppet.

2. The coupling assembly of claim 1, wherein the male and female coupling members are configured to secure to one another with a three-stage sealing structure.

3. The coupling assembly of claim 1, wherein the coupling assembly comprises disconnected mode, a partially connected mode, and a fully connected mode.

4. The coupling assembly of claim 1, wherein the coupling assembly further comprises a self-sealing valve.

5. The coupling assembly of claim 1, further comprising a thread type configuration to allow connection and disconnection from the system.

6. The coupling assembly of claim 1, wherein the coupling assembly comprises brass.

7. A coupling assembly comprising:
a female coupling member having a front portion and a rear portion, the female coupling member comprising at least one female sealing member, a first sleeve, a first spring, and a first poppet assembly; and
a male coupling member comprising at least one male sealing member, a second spring, and at least one male poppet assembly,
wherein the female coupling member is configured to couple to the male coupling member.

8. The coupling assembly of claim 7, wherein the female sealing member comprises a first resilient sealing member disposed at the front portion of the female coupling member and a second resilient sealing member disposed at the rear portion of the female coupling member.

9. The coupling assembly of claim 8, wherein the first spring may be disposed adjacent to the first resilient sealing member and the first poppet assembly may comprise a first poppet and a first bonded poppet.

10. The coupling assembly of claim 7, wherein the male sealing member comprises a third resilient sealing member and the second spring may be disposed adjacent to the third sealing member.

11. The coupling assembly of claim 10, wherein the male poppet assembly comprises a second poppet and a second bonded poppet.

12. The coupling assembly of claim 7, wherein the male and female coupling members are configured to secure to one another with a three-stage sealing structure.

13. The coupling assembly of claim 12, wherein the coupling assembly comprises a disconnected mode, a partially connected mode, and a fully connected mode.

14. The coupling assembly of claim 7, wherein the coupling assembly further comprises a self-sealing valve.

15. The coupling assembly of claim 7, further comprising a thread type configuration to allow connection and disconnection from a system.

16. The coupling assembly of claim 7, wherein the coupling assembly comprises brass.
